(19) United States
(12) Patent Application Publication
(10) Pub. No.: US 2024/0409783 A1
(43) Pub. Date: Dec. 12, 2024

(54) SEAM TAPES AND METHODS OF MAKING THE SAME

(71) Applicant: Bemis Associates, Inc., Shirley, MA (US)

(72) Inventors: Richard A. Brown, Danville, NH (US); Martin Bidleman, Lunenburg, MA (US); Theodore Y. Ngah, Dunstable, MA (US); Richard G. Goodwin, JR., Shrewsbury, MA (US)

(21) Appl. No.: 18/734,819

(22) Filed: Jun. 5, 2024

Related U.S. Application Data
(60) Provisional application No. 63/471,633, filed on Jun. 7, 2023.

(51) Int. Cl. C09J 7/35; B32B 5/02; B32B 27/08; B32B 27/12; B32B 27/36; B32B 27/40; C09J 7/10

(52) U.S. Cl. CPC C09J 7/35; B32B 5/02; B32B 27/08; B32B 27/12; B32B 27/36; B32B 27/40; C09J 7/10; B32B 2255/10; B32B 2270/00; B32B 2274/00; B32B 2307/308; B32B 2307/4023; B32B 2307/408; B32B 2307/704; B32B 2307/7376; B32B 2405/00; C09J 2203/358; C09J 2301/208; C09J 2301/304; C09J 2400/266; C09J 2467/00; C09J 2475/00

(57) ABSTRACT

Disclosed herein are monomaterial garments and seam tapes that may be recyclable and methods of producing the same.

### RELATED APPLICATIONS

This application claims the benefit of U.S. Provisional Application No. 63/471,633, filed Jun. 7, 2023, the teachings of which are incorporated herein by reference.

### BACKGROUND

Outerwear garments, such as coats and jackets, may be manufactured from materials that will allow the garment to be recycled. However, during assembly of the garment, seams are sewn to connect various fabric panels, and these seams are generally covered with a seam tape to cover the holes made during production. Generally, the seam tapes utilized in the construction of the outwear garments are not recyclable. Rather, seam tapes are generally adhered to the garment using a reactive polyurethane adhesive. This limits the recyclability of the garment.

### SUMMARY

Improved methods and product configurations have been identified that allow for customized colors and patterns, such as for projects that are small volume. The methods provide for reduced wastage.

Described herein are seam tapes, e.g., multi-layer seam tapes. In some embodiments, the seam tape is a two-layer seam tape. In other embodiments, the seam tape is a three-layer seam tape. In some embodiments, the seam tape includes a first polyester layer; and a second polyester layer, wherein the second polyester layer is an adhesive layer comprising a first resin, wherein the first resin has a high molecular weight, and a second resin, wherein the second resin has a low molecular weight.

In some embodiments, the first polyester layer comprises a single resin. The first polyester layer may include a thermoplastic polyester elastomer. In one embodiment, the first polyester layer comprises a thermoplastic polyether ester elastomer (TPEE).

In some embodiments, the first resin comprises a low melt flow index. For example, the first resin may comprise a melt flow index of about 50 to 75 g/10 mins at 175 C, 2.16 kg; a melt flow index of about 30 to 40 g/10 mins at 175 C, 2.16 kg; a melt flow index of about 40 to 65 g/10 mins at 175 C, 2.16 kg; or a melt flow index of about 100 to 110 g/10 mins at 155 C, 2.16 kg. In some embodiments, the first resin has a fast re-crystallization after melting.

In some embodiments, the second resin comprises a high melt flow index. In some embodiments, the second resin comprises a rapid melting resin. For example, the second resin may comprise a melt flow index of about 25 to 75 g/10 mins at 160 C, 2.16 kg; a melt flow index of about 25 to 35 g/10 mins at 160 C, 2.16 kg; a melt flow index of about 55 to 65 g/10 mins at 160 C, 2.16 kg; a melt flow index of about 45 to 55 g/10 mins at 155 C, 2.16 kg; or a melt flow index of about 50 g/10 mins at 155 C, 2.16 kg. In some embodiments, the second resin has a slow re-crystallization after melting.

In some embodiments, the first resin and the second resin each comprise a polyester adhesive resin. The second polyester layer may comprise a ratio of the first resin and the second resin at about 80:20. In some embodiments, the second polyester layer further comprises a thermoplastic polyurethane (TPU).

In some embodiments, the first polyester layer and/or the second polyester layer has a thickness of about 1 to 3 mil, optionally a thickness of about 2 mil. In some embodiments, the seam tape has a thickness of about 3 to 5 mil, optionally a thickness of about 4 mil. In some embodiments, the seam tape has a thickness of about 8 to 10 mil. In some embodiments, the seam tape has a width of about 10 to 20 mm.

In some embodiments, the first polyester layer comprises a matte finish. In some embodiments, the seam tape further includes an ink layer deposited on the first polyester layer. In some embodiments, the seam tape further includes a fabric layer adhered to the first polyester layer. The fabric layer may be adhered to the first polyester layer via a polyurethane thermosetting adhesive. In some embodiments, the first polyester layer and the second polyester layer are co-extruded to form a seam tape.

In some embodiments, the seam tape is adhered to a fabric, e.g., a garment. The fabric may include nylon, polyester, and/or cotton. In one embodiment, the fabric is a polyester fabric. In some embodiments, the seam tape is adhered to the fabric using a dual heating nozzle. The dual nozzle may heat the fabric surface and the second polyester layer to facilitate bonding. In some embodiments, the seam tape is adhered to a fabric, e.g., a garment, without the use of a polyurethane reactive adhesive.

### BRIEF DESCRIPTION OF THE FIGURES

Characteristics of the present invention will be more fully understood by reference to the following detailed description in conjunction with the attached drawings, in which:

FIG. 1 is a diagrammatic illustration showing the design of one embodiment of a seam tape described herein;

FIG. 2 is a diagrammatic illustration showing the design of one embodiment of a seam tape described herein;

FIG. 3 is a diagrammatic illustration showing the design of one embodiment of a seam tape described herein;

FIG. 4 is a diagrammatic illustration demonstrating the application of a two-layer seam tape described herein to a fabric;

FIG. 5 is a diagrammatic illustration demonstrating the application of a three-layer seam tape described herein to a fabric;

FIG. 6 provides a flow chart summarizing the production of a seam tape described herein and its application to a fabric;

FIG. 7 provides a photograph demonstrating the use of a dual nozzle to apply a seam tape described herein to a fabric;

FIG. 8 provides a photograph showing the results of hydrostatic testing of a cross-over seam resulting in no leaking; and

FIG. 9 provides a photograph showing the results of hydrostatic testing of a cross-over seam resulting in a leak.

### DETAILED DESCRIPTION

Disclosed herein are seam tapes (e.g., polyester seam tapes). The disclosed seam tapes are a polyester material allowing for their use on a polyester garment that produces a mono-material garment that can then be recycled at the end of the garment's life. The seam tapes may be applied during the production of a garment or after the garment is produced. In some aspects, the seam tape is applied to one or more seams formed when multiple fabric panels are connected. The seam tape can bond to the liner fabric and, in some aspects, cover pin holes created by stitching.

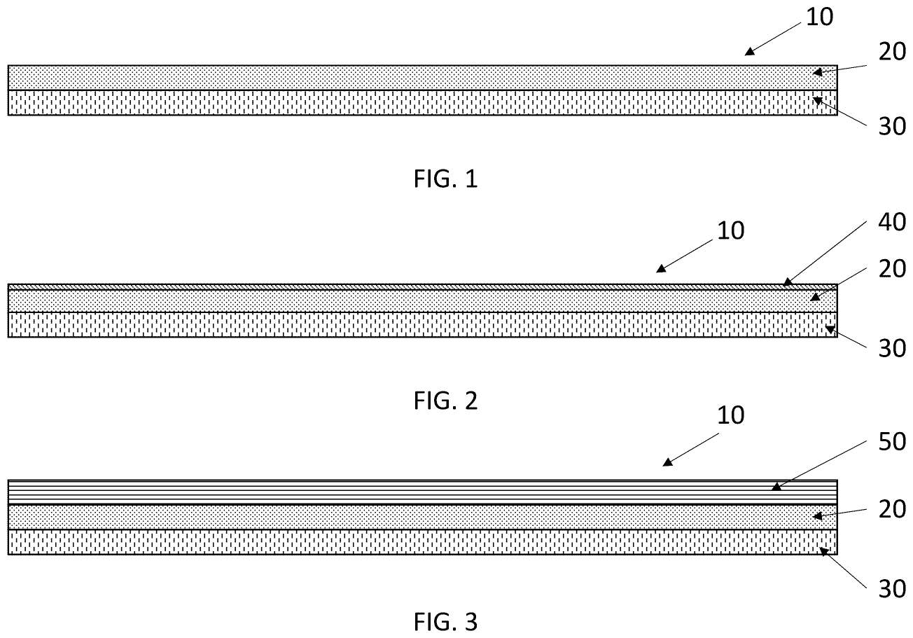

FIGS. 1-9, wherein like parts are designated by like reference numerals throughout, illustrate an example embodiment or embodiments of seam tapes and methods for forming, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

Aspects of the invention are directed to seam tapes. In some embodiments, a seam tape comprises a first polyester layer and a second polyester layer. The first polyester layer may also be referred to herein as a barrier layer. The second polyester layer may also be referred to herein as an adhesive layer. The seam tape may include a liner. In some aspects, the liner is removed prior to the application of the seam tape to the garment. In optional embodiments, the seam tape further includes a fabric layer (e.g., a tricot fabric layer). The tricot or fabric layer may be bonded to the first polyester layer of the seam tape. In some aspects, an adhesive or polyurethane (PUR) adheres the tricot or fabric layer to the first polyester layer. In alternative embodiments, an adhesive mesh or net is used to adhere the tricot or fabric layer to the first polyester layer.

In some embodiments, a first polyester layer comprises a resin, e.g., a single resin. The resin for the first polyester layer may also be referred to as a barrier layer or a membrane layer. In some embodiments, the first polyester layer comprises a resin having an ester and an ether component. The amount of polyether in a resin may contribute to the elasticity and/or water permeability of the first polyester layer. For example, a resin having a high level of polyethylene glycol will result in a first polyester layer that is very hydrophilic. In contrast, if the resin has a high level of polyTHF polyether this will result in a first polyester layer that is more hydrophobic. In some embodiments, the first polyester layer is waterproof. The first polyester layer may be formed of a resin that provides toughness and flexibility to the first polyester layer. In some embodiments, the first polyester layer comprises a resin having a high melting point. The resin of the first polyester layer may have a melting temperature of at least 180 C. In some embodiments, the resin has a melting temperature between 180 to 250 C, 180 to 240 C, 180 to 230 C, 180 to 220 C, 180 to 210 C, 180 to 200 C, 180 to 190 C, 190 to 250 C, 190 to 240 C, 190 to 230 C, 190 to 220 C, 190 to 210 C, 190 to 200 C, 200 to 250 C, 200 to 240 C, 200 to 230 C, 200 to 220 C, 200 to 210 C, 210 to 250 C, 210 to 240 C, 210 to 230 C, 210 to 220 C, 220 to 250 C, 220 to 240 C, 220 to 230 C, 230 to 250 C, 230 to 240 C, or 240 to 250 C. In some aspects, the resin has a melting temperature of about 180 C, 181 C, 182 C, 183 C, 184 C, 185 C, 186 C, 187 C, 188 C, 189 C, 190 C, 191 C, 192 C, 193 C, 194 C, 195 C, 196 C, 197 C, 198 C, 199 C, or 200 C. In some embodiments, the resin has a high molecular weight, optionally within the range of about 25,000-50,000. In some embodiments, the resin has a low melt flow index (MFI) for the barrier layer. In one embodiment, the resin has a melt flow index of less than 10 for g/10 min at 190 C, 2.16 kg. In one embodiment, the resin has a melt flow index of about 7-9 g/10 min at 210 C, 2.16 kg. In some embodiments, the first polyester layer comprises a thermoplastic polyester elastomer, e.g., a thermoplastic polyether ester elastomer (TPEE). Non-limiting examples of a resin for the first polyester layer include DuPont Hytrel grade resins (e.g., Hytrel 4068 or Hytrel 4056), Toyoba resins (e.g., Pelprene E450B), DSM resins (e.g., Arnitel VT3104), Cepat AG resins (e.g., Cepatex 180ES) or similar grades of resins from BASF or Covestro.

In some embodiments, the first polyester layer has a matte finish (e.g., embossed roughness). The matte finish may provide a nicer appearance than a glossy finish and may prevent the seam tape from sticking to itself or blocking. In some embodiments, the first polyester layer further includes a lubricating agent. Non-limiting examples of a lubricating agent include Glycolube P from Lonza or Azelis. In some embodiments, the lubricating agent may be added to the polyester layer resin at around 1% by weight. A lubricating agent facilitates the movement of the seam tape in a roller assembly of a seam sealing machine without catching or sticking. In some embodiments, a color or ink is applied to the first polyester layer. In certain aspects, the color or ink may be applied to the first polyester layer in a specific pattern.

In some embodiments, a second polyester layer comprises a first resin and a second resin. The first resin and the second resin may form a blend to form the second polyester layer. In optional embodiments, the second polyester layer further comprises a polyurethane thermoplastic polyurethane (TPU). In some embodiments, the first resin and the second resin are not the same material. The first resin may be referred to as a major or main resin and the second resin may be referred to as a minor resin. In some aspects, the first resin and the second resin are present at a ratio of about 60:40, 65:35, 70:30, 75:25, 80:20, 85:15, 90:10, or 95:5 first resin to second resin. In some embodiments, the first resin and the second resin are present at a ratio of about 70:30, 71:29, 72:28, 73:27, 74:26, 75:25, 76:24, 77:23, 78:22, 79:21, 80:20, 81:19, 82:18, 83:17, 84:16, 85:15, 86:14, 87:13, 88:12, 89:11, or 90:10. In one embodiment, the second polyester layer comprises a first resin and a second resin present at a ratio of 80:20 first resin to second resin. In some embodiments, the second polyester layer comprises about 50%, 55%, 60%, 65%, 70%, 75%, 80%, 85%, 90%, or 95% first resin. In some embodiments, the second polyester layer comprises about 70%, 71%, 72%, 73%, 74%, 75%, 76%, 77%, 78%, 79%, 80%, 81%, 82%, 83%, 84%, 85%, 86%, 87%, 88%, 89%, or 90% first resin. In some embodiments, the second polyester layer comprises about 5%, 10%, 15%, 20%, 25%, 30%, 35%, 40%, 45%, or 50% second resin. In some embodiments, the second polyester layer comprises about 10%, 11%, 12%, 13%, 14%, 15%, 16%, 17%, 18%, 19%, 20%, 21%, 22%, 23%, 24%, 25%, 26%, 27%, 28%, 29%, or 30% second resin.

In some embodiments, the first or major resin comprises an adhesive resin. In some embodiments, the first resin comprises a polyester, e.g., a copolyester, resin. The copolyester resin may have an aromatic content of terephthalic acid (TA) and isophthalic acid (IA). In some embodiments, the first resin has a melting temperature between 80 and 120 C, 85 and 120 C, 90 and 120 C, 95 and 120 C, 100 and 120 C, 105 and 120 C, 110 and 120 C, 80 and 115 C, 85 and 115 C, 90 and 115 C, 95 and 115 C, 100 and 115 C, 105 and 115 C, 80 and 110 C, 85 and 110 C, 90 and 110 C, 95 and 110 C, 100 and 110 C, 80 and 105 C, 85 and 105 C, 90 and 105 C, 95 and 105 C, 80 and 100 C, 85 and 100 C, 90 and 100 C, 80 and 95 C, 85 and 95 C, or 80 and 90 C. In some aspects, the first resin has a melting temperature of about 80 C, 85 C, 90 C, 95 C, 100 C, 105 C, 110 C, 115 C, or 120 C. In certain embodiments, the first resin has a melting temperature of about 90 C, 91 C, 92 C, 93 C, 94 C, 95 C, 96 C, 97 C, 98 C, 99 C, 100 C, 101 C, 102 C, 103 C, 104 C, 105 C, 106 C, 107 C, 108 C, 109 C, or 110 C. In one embodiment, the resin has a melting temperature of about 100 C. In some embodiments, the first resin has a high molecular weight, optionally within the range of about 25,000-50,000. In some embodiments, the first resin has a low melt flow index. In one embodiment, the first resin has a melt flow index of about 50-75 g/10 mins at 175 C, 2.16 kg. In one embodiment, the first resin has a melt flow index of about 30-40 g/10 mins at 175 C, 2.16 kg. In one embodiment, the first resin has a melt flow index of about 40-65 g/10 mins at 175 C, 2.16 kg. In one embodiment, the first resin has a melt flow index of about 100-110 g/10 mins at 155 C, 2.16 kg. In some embodiments, the first resin exhibits fast recrystallization after melting, e.g., crystallization occurs within 24 to 48 hours. For example, at room temperature, the first resin recrystallizes almost immediately after melting. Non-limiting examples of a first resin include ES8 from XinXin, PES 680V, 736V, 3230, 3235, or 3050 from Fixatti, Cepatex 105V from Cepat, GM-920 from Toyoba, and Eterkyd 50293C from Eternal.

In some embodiments, the second or minor resin comprises an adhesive resin. In some embodiments, the second resin comprises a polyester, e.g., a copolyester, resin. The second resin may be different than the first resin. In some embodiments, the second resin has a melting temperature between 90 and 130 C, 95 and 130 C, 100 and 130 C, 105 and 130 C, 110 and 130 C, 115 and 130 C, 120 and 130 C, 90 and 125 C, 95 and 125 C, 100 and 125 C, 105 and 125 C, 110 and 125 C, 115 and 125 C, 90 and 120 C, 95 and 120 C, 100 and 120 C, 105 and 120 C, 110 and 120 C, 90 and 115 C, 95 and 115 C, 100 and 115 C, 105 and 115 C, 90 and 110 C, 95 and 110 C, 100 and 110 C, 90 and 105 C, 95 and 105 C, or 90 and 100 C. In some aspects, the second resin has a melting temperature of about 90 C, 95 C, 100 C, 105 C, 110 C, 115 C, 120 C, 125 C, or 130 C. In certain embodiments, the second resin has a melting temperature of about 105 C, 106 C, 107 C, 108 C, 109 C, 110 C, 111 C, 112 C, 113 C, 114 C, 115 C, 116 C, 117 C, 118 C, 119 C, 120 C, 121 C, 122 C, 123 C, 124 C, 125 C, 126 C, 127 C, 128 C, 129 C, or 130 C. In one embodiment, the second resin has a melting temperature of about 117 C. In some embodiments, the second resin has a low molecular weight, optionally within the range of about 10,000-20,000. In some embodiments, the second resin has a high melt flow index. In some embodiments, the second resin has a melt flow index of about 25-75 g/10 mins at 160 C, 2.16 kg. In one embodiment, the second resin has a melt flow index of about 25-35 g/10 mins at 160 C, 2.16 kg. In one embodiment, the second resin has a melt flow index of about 55-65 g/10 mins at 160 C, 2.16 kg. In one embodiment, the second resin has a melt flow index of about 45-55 g/10 mins at 155 C, 2.16 kg. In some embodiments, the second resin exhibits slow recrystallization after melting. For example, at room temperature, the second resin recrystallizes about two weeks after melting. Non-limiting examples of a second resin include ES-702, ES-502, and ES-700 from Griltex-EMS, and GM-920 from Toyoba Japan. In one embodiment, the second resin comprises a blend of polyester adhesives, e.g., a blend of ES-702 and ES-502.

In some embodiments, the blend of the first resin and the second resin exhibits a fast recrystallization after melting. In some embodiments, the blend of the first resin and the second resin has a melting temperature between 85 and 115 C, 90 and 115 C, 95 and 115 C, 100 and 115 C, 105 and 115 C, 85 and 110 C, 90 and 110 C, 95 and 110 C, 100 and 110 C, 85 and 105 C, 90 and 105 C, 95 and 105 C, 85 and 100 C, 90 and 100 C, or 85 and 95 C. In some aspects, the first resin has a melting temperature of about 80 C, 85 C, 90 C, 95 C, 100 C, 105 C, 110 C, 115 C, or 120 C. In some embodiments, the blend of the first resin and the second resin exhibits a melting temperature of about 85 C, 86 C, 87 C, 88 C, 89 C, 90 C, 91 C, 92 C, 93 C, 94 C, 95 C, 96 C, 97 C, 98 C, 99 C, 100 C, 101 C, 102 C, 103 C, 104 C, or 105 C. In one embodiment, the blend of the first resin and the second resin exhibits a melting temperature of about 97 C.

In some embodiments, the second polyester layer further comprises a polyurethane thermoplastic urethane (TPU). In some embodiments, an amount of TPU is added in an amount of 10% to 100% of the adhesive layer. Non-limiting examples of a TPU include AH-535 or AH-560 from BASF Elastollan Hotbond.

The seam tape described herein may have a thickness of about 2 to 10 mil and a width of about 10 to 80 mm. In some embodiments, the seam tape has a thickness of about 2.5 to 10 mil, 3 to 10 mil, 3.5 to 10 mil, 4 to 10 mil, 4.5 to 10 mil, 5 to 10 mil, 5.5 to 10 mil, 6 to 10 mil, 6.5 to 10 mil, 7 to 10 mil, 7.5 to 10 mil, 8 to 10 mil, 8.5 to 10 mil, 9 to 10 mil, 9.5 to 10 mil, 3 to 9.5 mil, 3.5 to 9.5 mil, 4 to 9.5 mil, 4.5 to 9.5 mil, 5 to 9.5 mil, 5.5 to 9.5 mil, 6 to 9.5 mil, 6.5 to 9.5 mil, 7 to 9.5 mil, 7.5 to 9.5 mil, 8 to 9.5 mil, 8.5 to 9.5 mil, 9 to 9.5 mil, 3 to 9 mil, 3.5 to 9 mil, 4 to 9 mil, 4.5 to 9 mil, 5 to 9 mil, 5.5 to 9 mil, 6 to 9 mil, 6.5 to 9 mil, 7 to 9 mil, 7.5 to 9 mil, 8 to 9 mil, 8.5 to 9 mil, 3 to 8.5 mil, 3.5 to 8.5 mil, 4 to 8.5 mil, 4.5 to 8.5 mil, 5 to 8.5 mil, 5.5 to 8.5 mil, 6 to 8.5 mil, 6.5 to 8.5 mil, 7 to 8.5 mil, 7.5 to 8.5 mil, 8 to 8.5 mil, 3 to 8 mil, 3.5 to 8 mil, 4 to 8 mil, 4.5 to 8 mil, 5 to 8 mil, 5.5 to 8 mil, 6 to 8 mil, 6.5 to 8 mil, 7 to 8 mil, 7.5 to 8 mil, 3 to 7.5 mil, 3.5 to 7.5 mil, 4 to 7.5 mil, 4.5 to 7.5 mil, 5 to 7.5 mil, 5.5 to 7.5 mil, 6 to 7.5 mil, 6.5 to 7.5 mil, 7 to 7.5 mil, 3 to 7 mil, 3.5 to 7 mil, 4 to 7 mil, 4.5 to 7 mil, 5 to 7 mil, 5.5 to 7 mil, 6 to 7 mil, 6.5 to 7 mil, 3 to 6.5 mil, 3.5 to 6.5 mil, 4 to 6.5 mil, 4.5 to 6.5 mil, 5 to 6.5 mil, 5.5 to 6.5 mil, 6 to 6.5 mil, 3 to 6 mil, 3.5 to 6 mil, 4 to 6 mil, 4.5 to 6 mil, 5 to 6 mil, 5.5 to 6 mil, 3 to 5.5 mil, 3.5 to 5.5 mil, 4 to 5.5 mil, 4.5 to 5.5 mil, 5 to 5.5 mil, 3 to 5 mil, 3.5 to 5 mil, 4 to 5 mil, 4.5 to 5 mil, 3 to 4.5 mil, 3.5 to 4.5 mil, 4 to 4.5 mil, 3 to 4 mil, 3.5 to 4 mil, or 3 to 3.5 mil. In certain embodiments, the seam tape has a thickness of about 3 mil, 3.1 mil, 3.2 mil, 3.3 mil, 3.4 mil, 3.5 mil, 3.6 mil, 3.7 mil, 3.8 mil, 3.9 mil, 4 mil, 4.1 mil, 4.2 mil, 4.3 mil, 4.4 mil, 4.5 mil, 4.6 mil, 4.7 mil, 4.8 mil, 4.9 mil, 5 mil, 5.1 mil, 5.2 mil, 5.3 mil, 5.4 mil, 5.5 mil, 5.6 mil, 5.7 mil, 5.8 mil, 5.9 mil, 6.0 mil, 6.1 mil, 6.2 mil, 6.3 mil, 6.4 mil, 6.5 mil, 6.6 mil, 6.7 mil, 6.8 mil, 6.9 mil, 7 mil, 7.1 mil, 7.2 mil, 7.3 mil, 7.4 mil, 7.5 mil, 7.6 mil, 7.7 mil, 7.8 mil, 7.9 mil, 8 mil, 8.1 mil, 8.2 mil, 8.3 mil, 8.4 mil, 8.5 mil, 8.6 mil, 8.7 mil, 8.8 mil, 8.9 mil, or 9 mil. In one embodiment, the seam tape has a thickness of about 4 mil. In one embodiment, the seam tape has a thickness of about 5 mil. In one embodiment, the seam tape has a thickness of about 6 mil. In one embodiment, the seam tape has a thickness of about 9 mil.

In some embodiments, a layer of the seam tape (e.g., the first polyester layer, the second polyester layer, or any optional additional layers) has a thickness of about 1 to 3 mil, 1.25 to 3 mil, 1.5 to 3 mil, 1.75 to 3 mil, 2 to 3 mil, 2.25 to 3 mil, 2.5 to 3 mil, 2.75 to 3 mil, 1 to 2.75 mil, 1.25 to 2.75 mil, 1.5 to 2.75 mil, 1.75 to 2.75 mil, 2 to 2.75 mil, 2.25 to 2.75 mil, 2.5 to 2.75 mil, 1 to 2.5 mil, 1.25 to 2.5 mil, 1.5 to 2.5 mil, 1.75 to 2.5 mil, 2 to 2.5 mil, 2.25 to 2.5 mil, 1 to 2.25 mil, 1.25 to 2.25 mil, 1.5 to 2.25 mil, 1.75 to 2.25 mil, 2 to 2.25 mil, 1 to 2 mil, 1.25 to 2 mil, 1.5 to 2 mil, 1.75 to 2 mil, 1 to 1.75 mil, 1.25 to 1.75 mil, 1.5 to 1.75 mil, 1 to 1.5 mil, 1.25 to 1.5 mil, or 1 to 1.25 mil. In certain embodiments, the first polyester layer and/or the second polyester layer has a thickness of about 1 mil, 1.1 mil, 1.2 mil, 1.3 mil, 1.4 mil, 1.5 mil, 1.6 mil, 1.7 mil, 1.8 mil, 1.9 mil, 2 mil, 2.1 mil, 2.2 mil, 2.3 mil, 2.4 mil, 2.5 mil, 2.6 mil, 2.7 mil, 2.8 mil, 2.9 mil, or 3 mil. In one embodiment, a layer of the seam tape has a thickness of about 2 mil. In one embodiment, a layer of the seam tape has a thickness of about 2.5 mil. In one embodiment, a layer of the seam tape has a thickness of about 3 mil. In some embodiments a layer of the seam tape has a thickness of about 5 to 8 mil, 5.5 to 8 mil, 6 to 8 mil, 6.5 to 8 mil, 7 to 8 mil, 7.5 to 8 mil, 5 to 7.5 mil, 5.5 to 7.5 mil, 6 to 7.5 mil, 6.5 to 7.5 mil, 7 to 7.5 mil, 5 to 7 mil, 5.5 to 7 mil, 6 to 7 mil, 6.5 to 7 mil, 5 to 6.5 mil, 5.5 to 6.5 mil, 6 to 6.5 mil, 5 to 6 mil, 5.5 to 6 mil, or 5 to 5.5 mil. In certain embodiments, a layer of the seam tape has a thickness of about 6 mil, 6.1 mil, 6.2 mil, 6.3 mil, 6.4 mil, 6.5 mil, 6.6 mil, 6.7 mil, 6.8 mil, 6.9 mil, 7 mil, 7.1 mil, 7.2 mil, 7.3 mil, 7.4 mil, 7.5 mil, 7.6 mil, 7.7 mil, 7.8 mil, 7.9 mil, or 8 mil. In one embodiment, a layer of the seam tape has a thickness of about 7 mil.

In some embodiments, the seam tape has a width of about 10 to 80 mm, 20 to 80 mm, 30 to 80 mm, 40 to 80 mm, 50 to 80 mm, 60 to 80 mm, 70 to 80 mm, 10 to 70 mm, 20 to 70 mm, 30 to 70 mm, 40 to 70 mm, 50 to 70 mm, 60 to 70 mm, 10 to 60 mm, 20 to 60 mm, 30 to 60 mm, 40 to 60 mm, 50 to 60 mm, 10 to 50 mm, 20 to 50 mm, 30 to 50 mm, 40 to 50 mm, 10 to 40 mm, 20 to 40 mm, 30 to 40 mm, 10 to 30 mm, 20 to 30 mm, or 10 to 20 mm. In certain embodiments, the seam tape has a width of about 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, or 30 mm. In one embodiment, the seam tape has a width of about 19-20 mm. In one embodiment, the seam tape has a width of about 13-15 mm.

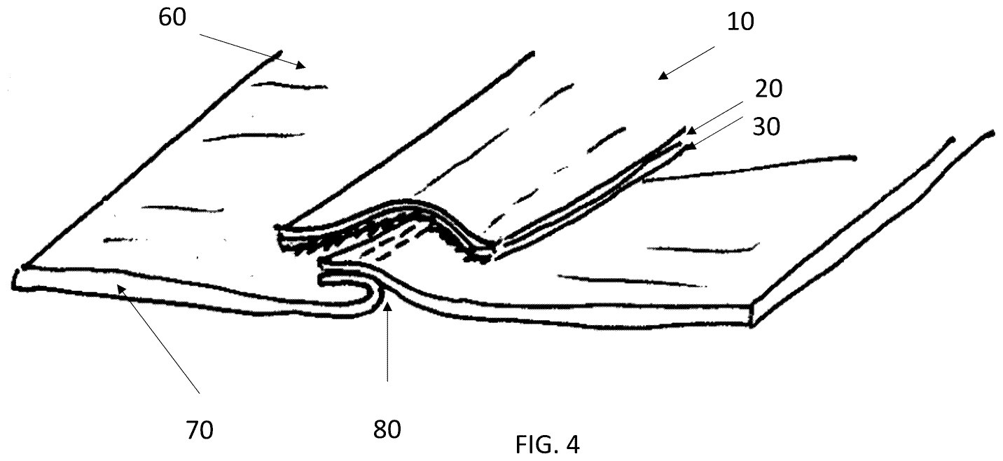

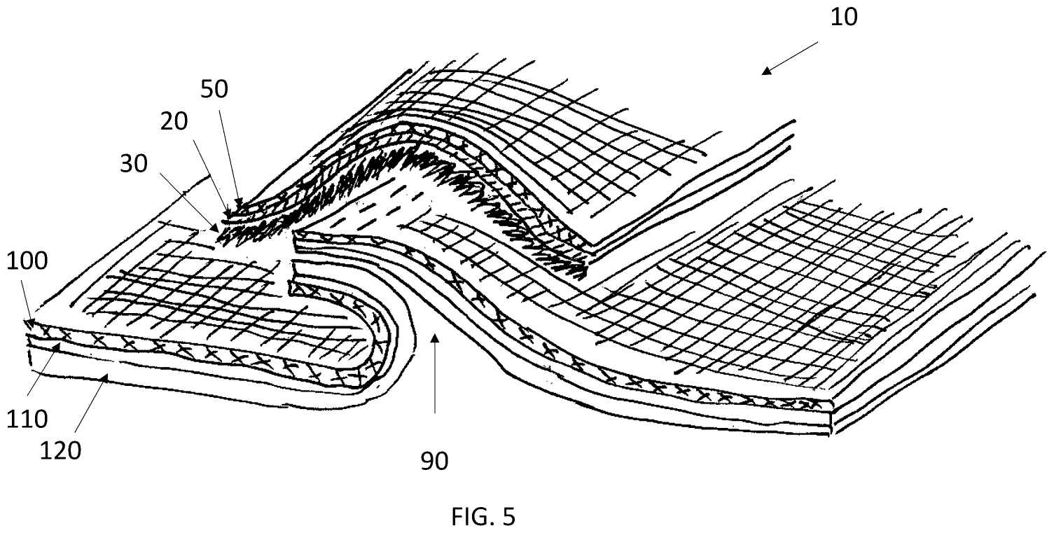

A seam tape 10 as shown in FIG. 1 comprises a first polyester layer or barrier layer 20 and a second polyester layer or adhesive layer 30. Optionally, as shown in FIG. 2, seam tape 10 may further include an ink or color layer 40 deposited on the barrier layer 10. In other optional embodiments, as shown in FIG. 3, seam tape 10 may further include a fabric (e.g., tricot) layer 50. The tricot layer 50 may be adhered to barrier layer 20. Seam tape 10 may be adhered to a garment to cover a seam 80, e.g., a seam joining garment panels. The garment panels may have an outer garment layer 70 and an inner garment layer 60, e.g., a membrane layer (FIG. 4). In alternative embodiments, a seam tape 10 having a barrier layer 20, adhesive layer 30, and tricot layer 50 may be adhered to a garment to cover a seam 90 formed in a fabric having a tricot layer. The garment may have an inner tricot layer 100, a fabric membrane 110, and a fabric outer layer 120 (FIG. 5).

In some embodiments, the first polyester layer is bonded to the second polyester layer. In some embodiments, a two-layer seam tape is produced by extruding the first polyester layer and the second polyester layer. The first polyester layer and the second polyester layer may be extruded simultaneously onto a paper or plastic liner. In some aspects, the extruded material on the liner may be formed into a roll and stored. In some aspects, the roll may be unwound, the liner removed, and the unwound roll slit into separate rolls having a smaller width to form the two-layer seam tape. In optional embodiments, a three-layer seam tape is produced by bonding a fabric layer (e.g., a tricot fabric layer) to the first polyester layer of the seam tape. The tricot or fabric layer may be bonded to the barrier layer using an adhesive or alternatively using PUR. In other embodiments, an extruded polyester mesh or net film laminates the tricot layer to the first polyester layer of a two-layer seam tape. In one embodiment, the two-layer seam tape may have a thicker adhesive layer than the barrier layer.

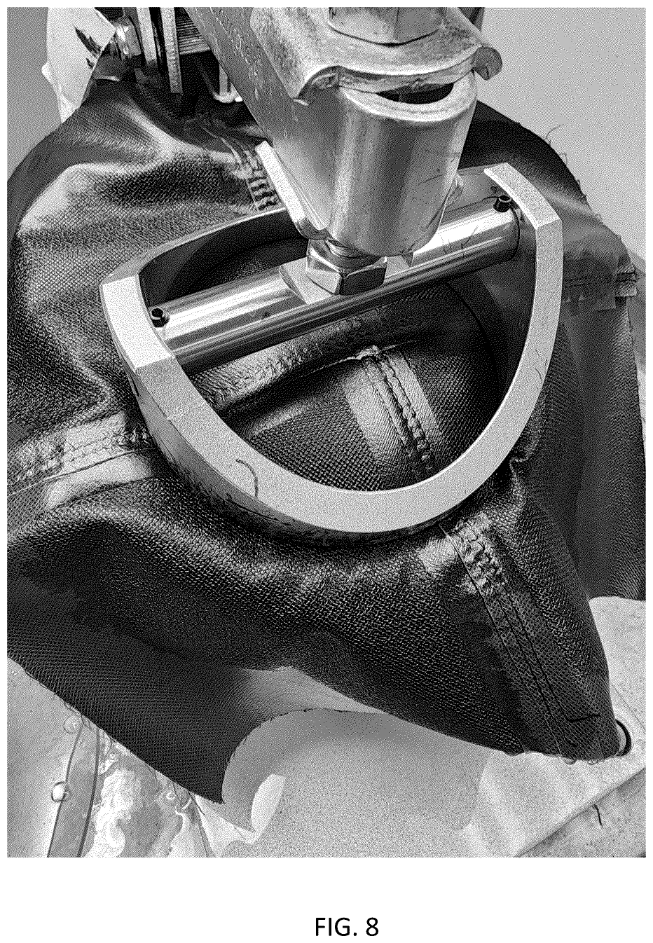

The seam tape may be applied to a fabric, e.g., along the seam where two pieces of fabric are connected. In some embodiments, the fabric comprises a nylon, cotton, or polyester. In one embodiment, the fabric is polyester. In some embodiments, the fabric is waterproof, e.g., the fabric can pass a hydrostatic water pressure test of 3 lbs pressure for 2 mins (FIG. 8). In some embodiments, the fabric is a garment. Hydrostatic testing comprises testing water pressure resistance according to one or more test standards, including, but not limited to AATCC 127 (AATCC TM127-2017 (2018) e, Test Method for Water Resistance: Hydrostatic Pressure, developed in 1968 by AATCC Committee RA63 (Reaffirmed 2018; Editorially Revised 2019)); AATCC 35 (AATCC TM35-2018e, Test Method for Water Resistance: Rain, developed in 1947 by AATCC Committee RA63); BS EN ISO 811 (BS EN 20811 ISO 811, Textiles-Determination of resistance to water penetration-Hydrostatic pressure test, 2018 Edition, May 31, 2018); and NWSP 80.6 (NWSP 80.6 Evaluation of Water Resistance (Hydrostatic Pressure) Test).

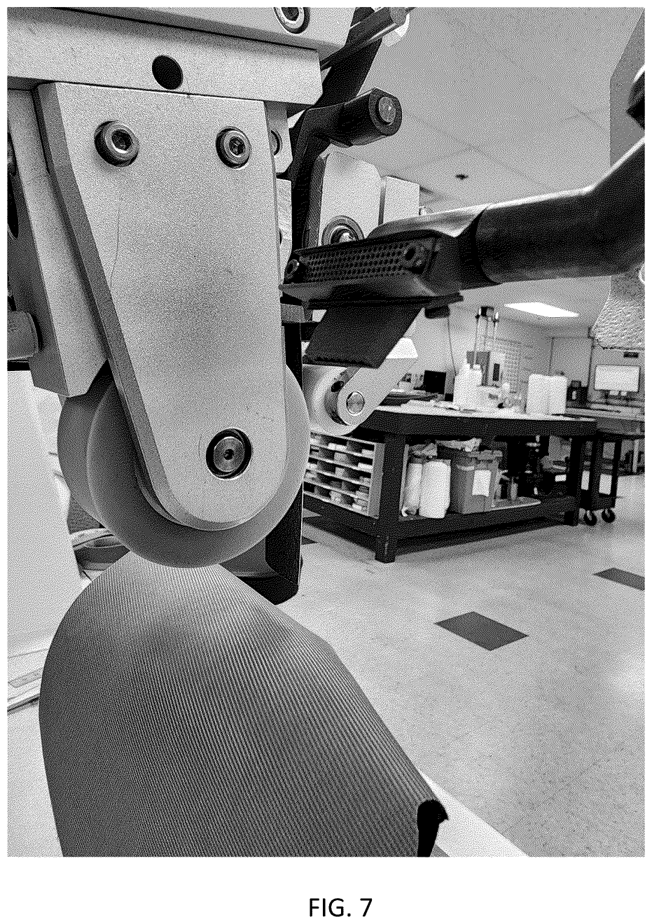

The seam tape may be applied to a fabric, e.g., a garment, using a dual nozzle heating system (FIG. 7). In some embodiments, the seam tape is bonded to the fabric using a dual nozzle. In other embodiments, the steam tape is bonded to the fabric using a single nozzle where the nozzle is set close to the nip. In some embodiments, the seam tape is applied to a fabric using a hot air seam sealing machine. The sealing machine may include rubber rollers which may pin the seam tape to a fabric. The fabric may be moved through the machine at a slow speed rate, e.g., a speed of about 5 to 20 ft/min. In one embodiment, the fabric is moved through the machine at a speed of about 9 to 16 ft/min. The pressure of the rubber rollers pinning the tape to the fabric is about 40 to 60 psi. In some embodiments, the dual nozzle system allows for hot air to be applied to the fabric and the tape simultaneously as the seam tape and the fabric are moved through the sealing machine.

In some aspects, both nozzles of the dual nozzle heating system are heated to the same temperature. In some aspects, each nozzle of the dual nozzle heating system are set to different temperatures. One or both of the dual nozzles may be set to a temperature of about 400 to 700 F, 425 to 700 F, 450 to 700 F, 475 to 700 F, 500 to 700 F, 525 to 700 F, 550 to 700 F, 575 to 700 F, 600 to 700 F, 625 to 700 F, 650 to 700 F, 675 to 700 F, 400 to 675 F, 425 to 675 F, 450 to 675 F, 475 to 675 F, 500 to 675 F, 525 to 675 F, 550 to 675 F, 575 to 675 F, 600 to 675 F, 625 to 675 F, 650 to 675 F, 400 to 650 F, 425 to 650 F, 450 to 650 F, 475 to 650 F, 500 to 650 F, 525 to 650 F, 550 to 650 F, 575 to 650 F, 600 to 650 F, 625 to 650 F, 400 to 625 F, 425 to 625 F, 450 to 625 F, 475 to 625 F, 500 to 625 F, 525 to 625 F, 550 to 625 F, 575 to 625 F, 600 to 625 F, 400 to 600 F, 425 to 600 F, 450 to 600 F, 475 to 600 F, 500 to 600 F, 525 to 600 F, 550 to 600 F, 575 to 600 F, 400 to 575 F, 425 to 575 F, 450 to 575 F, 475 to 575 F, 500 to 575 F, 525 to 575 F, 550 to 575 F, 400 to 550 F, 425 to 550 F, 450 to 550 F, 475 to 550 F, 500 to 550 F, 525 to 550 F, 400 to 525 F, 425 to 525 F, 450 to 525 F, 475 to 525 F, 500 to 525 F, 400 to 500 F, 425 to 500 F, 450 to 500 F, 475 to 500 F, 400 to 475 F, 425 to 475 F, 450 to 475 F, 400 to 450 F, 425 to 450 F, or 400 to 425 F.

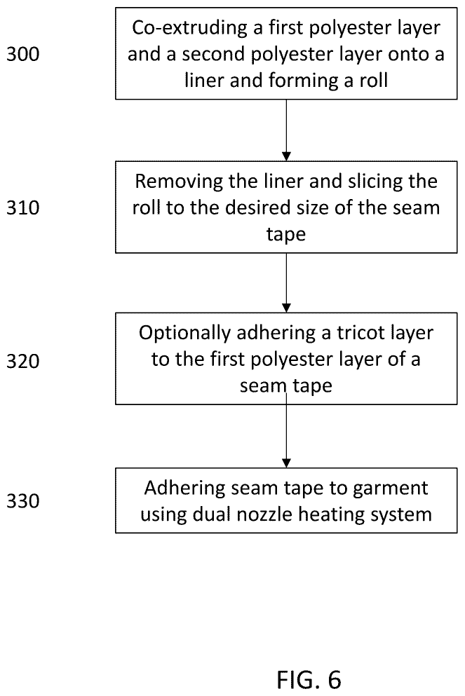

An exemplary method for producing and adhering a seam tape to a garment is shown in FIG. 6. A first polyester layer and a second polyester layer may be co-extruded onto a liner and formed into a roll 300. The liner may eventually be removed and the roll is sliced into individual rolls to form a two-layer seam tape 310. In optional embodiments, a tricot layer is adhered to the first polyester layer to form a three-layer seam tape 320. A two- or three-layer seam tape is adhered to a fabric, e.g., a garment, using a dual nozzle and a sealing machine 330.

One skilled in the art readily appreciates that the present invention is well adapted to carry out the objects and obtain the ends and advantages mentioned, as well as those inherent therein. The details of the description and the examples herein are representative of certain embodiments, are exemplary, and are not intended as limitations on the scope of the invention. Modifications therein and other uses will occur to those skilled in the art. These modifications are encompassed within the spirit of the invention. It will be readily apparent to a person skilled in the art that varying substitutions and modifications may be made to the invention disclosed herein without departing from the scope and spirit of the invention.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. It is contemplated that all embodiments described herein are applicable to all different aspects of the invention where appropriate. It is also contemplated that any of the embodiments or aspects can be freely combined with one or more other such embodiments or aspects whenever appropriate. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity, those embodiments have not in every case been specifically set forth in so many words herein. It should also be understood that any embodiment or aspect of the invention can be explicitly excluded from the claims, regardless of whether the specific exclusion is recited in the specification. For example, any one or more active agents, additives, ingredients, optional agents, types of organism, disorders, subjects, or combinations thereof, can be excluded.

Where ranges are given herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. It is also understood that where a series of numerical values is stated herein, the invention includes embodiments that relate analogously to any intervening value or range defined by any two values in the series, and that the lowest value may be taken as a minimum and the greatest value may be taken as a maximum. Numerical values, as used herein, include values expressed as percentages. For any embodiment of the invention in which a numerical value is prefaced by “about” or “approximately”, the invention includes an embodiment in which the exact value is recited. For any embodiment of the invention in which a numerical value is not prefaced by “about” or “approximately”, the invention includes an embodiment in which the value is prefaced by “about” or “approximately”.

“Approximately” or “about” generally includes numbers that fall within a range of 1% or in some embodiments within a range of 5% of a number or in some embodiments within a range of 10% of a number in either direction (greater than or less than the number) unless otherwise stated or otherwise evident from the context (except where such number would impermissibly exceed 100% of a possible value). It should be understood that, unless clearly indicated to the contrary, in any methods claimed herein that include more than one act, the order of the acts of the method is not necessarily limited to the order in which the acts of the method are recited, but the invention includes embodiments in which the order is so limited. It should also be understood that unless otherwise indicated or evident from the context, any product or composition described herein may be considered “isolated”.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

It is to be understood that the inventions disclosed herein are not limited in their application to the details set forth in the description or as exemplified. The invention encompasses other embodiments and is capable of being practiced or carried out in various ways. Also, it is to be understood that the phraseology and terminology employed herein is for the purpose of description and should not be regarded as limiting.

While certain compositions and methods of the present invention have been described with specificity in accordance with certain embodiments, the following examples serve only to illustrate the methods and compositions of the invention and are not intended to limit the same.

### EXEMPLIFICATION

Prototypes of 2-layer and 3-layer tapes were prepared using the methods described herein and were tested using hydrostatic testing. An exemplary 2-layer and 3-layer all polyester tape are as follows:
1. All-polyester, 2-layer: Hytrel 4068 2 mil barrier+Adhesive of Fixatti 680v (80%)/EMS Griltex ES702 (20%), 2 mil
2. All-polyester, 3-layer: Hytrel 4068, 2 mil+Griltex ES702 (60%)/Griltex ES502 (40%) 6 mil or 8 mil.
   Additional adhesives prepared and tested for use in preparing the seam tapes include an adhesive having a mix of Fixatti 680v (80%) and 20% of a highly crystallizing TPU and an adhesive that is an all TPU adhesive with 80% crystallizing TPU and 20% non-crystallizing TPU. Both adhesives were tested on a Hytrel TPEE barrier.

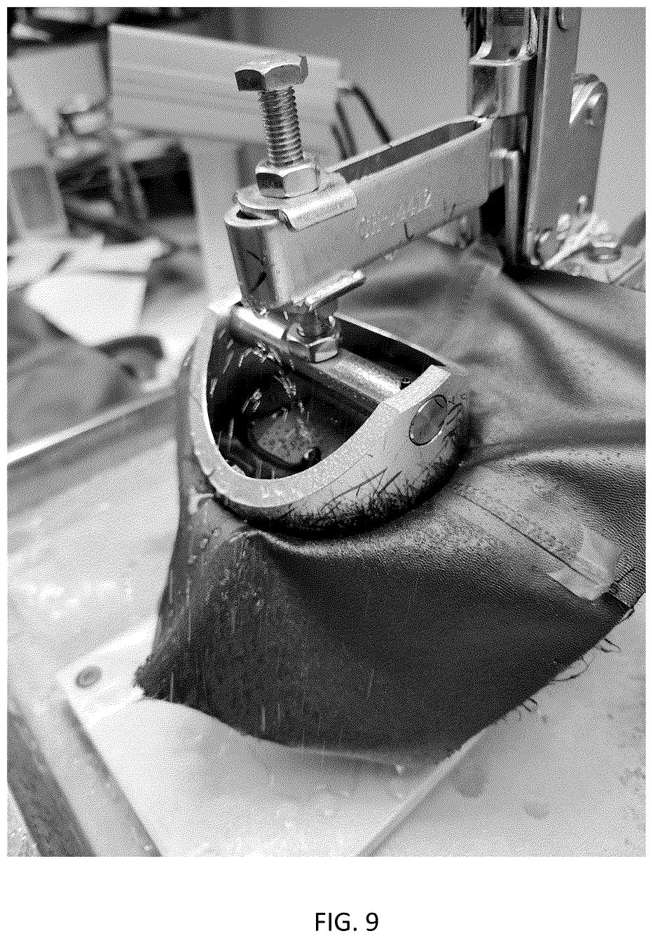

Seams prepared using the tapes were assessed under hydrostatic testing conditions. The results of the hydrostatic testing of cross over tapes can be seen in FIG. 8 (passed) and FIG. 9 (failed).

What is claimed is:

1. A seam tape comprising:
a) a first polyester layer; and
b) a second polyester layer, wherein the second polyester layer is an adhesive layer comprising:
i) a first resin, wherein the first resin has a high molecular weight; and
ii) a second resin, wherein the second resin has a low molecular weight.

2. The seam tape of claim 1, wherein the first polyester layer comprises a thermoplastic polyester elastomer.

3. The seam tape of claim 1, wherein the first resin comprises a low melt flow index.

4. The seam tape of claim 1, wherein the first resin comprises a melt flow index of about 50 to 75 g/10 mins at 175 C, 2.16 kg; 30 to 40 g/10 mins at 175 C, 2.16 kg; 40 to 65 g/10 mins at 175 C, 2.16 kg; or 100 to 110 g/10 mins at 155 C, 2.16 kg.

5. The seam tape of claim 1, wherein the first resin has a fast re-crystallization after melting.

6. The seam tape of claim 1, wherein the second resin comprises a high melt flow index.

7. The seam tape of claim 1, wherein the second resin comprises a rapid melting resin.

8. The seam tape of claim 1, wherein the second resin comprises a melt flow index of about 25 to 75 g/10 mins at 160 C, 2.16 kg; 25 to 35 g/10 mins at 160 C, 2.16 kg; 55 to 65 g/10 mins at 160 C, 2.16 kg; 45 to 55 g/10 mins at 155 C, 2.16 kg; or 50 g/10 mins at 155 C, 2.16 kg.

9. The seam tape of claim 1, wherein the second resin has a slow re-crystallization after melting.

10. The seam tape of claim 1, wherein the first resin and the second resin each comprise a polyester adhesive resin.

11. The seam tape of claim 1, wherein the second polyester layer comprises a ratio of the first resin and the second resin at about 80:20.

12. The seam tape of claim 1, wherein the second polyester layer further comprises a thermoplastic polyurethane (TPU).

13. The seam tape of claim 1, wherein the first polyester layer and/or the second polyester layer has a thickness of about 1 to 3 mil.

14. The seam tape of claim 1, wherein the seam tape has a thickness of about 3 to 5 mil or 8 to 10 mil.

15. The seam tape of claim 1, wherein the seam tape has a width of about 10 to 20 mm.

16. The seam tape of claim 1, wherein the first polyester layer comprises a matte finish.

17. The seam tape of claim 1, further comprising an ink layer deposited on the first polyester layer.

18. The seam tape of claim 1, further comprising a fabric layer adhered to the first polyester layer.

19. The seam tape of claim 1, wherein the first polyester layer and the second polyester layer are co-extruded to form a seam tape.

20. The seam tape of claim 1, wherein the seam tape is adhered to a fabric.
